(19) United States
(12) Patent Application Publication
(10) Pub. No.: US 2003/0002148 A1
(43) Pub. Date: Jan. 2, 2003

(54) Arrangement for optically scanning an object

(76) Inventor: Johann Engelhardt, Bad Schonborn (DE)

Correspondence Address: SIMPSON & SIMPSON, PLLC, 5555 MAIN STREET, WILLIAMSVILLE, NY, 14221-5406, US

(21) Appl. No.: 10/201,225

(22) Filed: Jul. 22, 2002

Related U.S. Application Data
(63) Continuation of application No. 09/582,177, filed on Jun. 22, 2000.
Application No. 09/582,177 is a 371 of international application No. PCT/DE99/03400, filed on Oct. 25, 1999.

(30) Foreign Application Priority Data
Oct. 24, 1998 (DE) 198 49 143.3

(51) Int. Cl. G02B 26/08

(52) U.S. Cl. 359/368; 359/202; 359/385; 359/431

(57) ABSTRACT

An arrangement for optical scanning of a specimen, in particular in preferably confocal laser scanning microscopy, a lens or an objective (3) and at least one scanning mirror (4) being arranged in the illumination/detection beam path (1, 2), is characterized, for scanning specimen fields that exceed the specimen field size of the microscope optical system with sufficiently rapid data recording using simple optical components, in that the mirror (4) rotates or pivots with a rotation axis (5) that is at least largely orthogonal to the scanned surface of the specimen.

### CROSS-REFERENCES TO RELATED APPLICATIONS

This continuation patent application under 35 U.S.C. §120 which claims the benefit of U.S. application Ser. No. 09/582,177, filed Jun. 22, 2000, incorporated by reference herein. The present application also claims priority under 35 U.S.C §371 of International Application No. PCT/DE99/03400 filed Oct. 25, 1999, published in English.

### BACKGROUND OF THE INVENTION

The invention concerns an arrangement for optical scanning of a specimen, in particular in preferably confocal laser scanning microscopy, a lens or an objective and at least one scanning mirror being arranged in the illumination/detection beam path.

Arrangements of the generic type are used in particular for the detection of “micro-array bichips” (MABs). MABs are utilized in medical diagnosis, where a large number of MABs must be examined and evaluated in a short period of time. Specimen slides in which a large number of specific detection regions (“spots”) are applied, preferably in grid form, can be used as the MABs. These detection regions usually have a diameter of approximately 50 to 100 μm, and must be examined in terms of their fluorescent properties. The spots are distributed on a specimen slide on a specimen field of up to 22×60 mm.

With a conventional confocal laser scanning microscope (CLSM) it is possible, however, to image specimens distributed over such large fields all at once, since the specimen fields on the microscope objectives usable for such applications are too small for the purpose. The use of larger objectives or lenses when the beam is moved relative to the lenses results in image irregularities and intensity fluctuations. The image irregularities are caused by residual and imaging errors of the lens used, and the intensity fluctuations by partial contamination of the optical components in the beam path.

In addition, the illumination beam path of the CLSMs is configured such that the diffraction-limited scanning beam generally has a diameter in the range from 1 to 2 μm in the specimen plane. As a result, the specimens are scanned with a spatial resolution that is unnecessary and much too high for these applications. In addition, laboratory operation requires a high throughput of specimen slides for examination, and this cannot be achieved with the CLSMs known heretofore.

DE 26 40 282 A1 discloses, per se, an arrangement for optical scanning of a specimen in which a scanning mirror is mounted rotatably about two axes, one of the two rotation axes coinciding with the optical axis of the incident light beam.

### SUMMARY OF THE INVENTION

It is therefore the object of the present invention to describe an arrangement for optical scanning of specimens with which it is possible to scan a specimen field that exceeds the specimen field size of the microscope optical system. In addition, the arrangement is also intended to make possible sufficiently rapid data recording using simple optical components.

The aforesaid object is achieved by the features of claim 1, according to which an arrangement for optical scanning of a specimen, in particular in preferably confocal laser scanning microscopy, is characterized in that the mirror rotates or pivots with a rotation axis that is at least largely orthogonal to the scanned surface of the specimen.

What has first of all been recognized accordingly to the present invention is that MABs or specimen slides of conventional size can easily and rapidly be scanned, with a relatively low-magnification optical system, using a scanning device. The scanning apparatus contains the rotatably arranged optical components, but a least one scanning mirror arranged in the illumination/detection beam path. The mirror is arranged in the illumination/detection beam path in such a way that a specimen can be scanned by rotation or pivoting about a rotation axis that is at least largely orthogonal to the scanned surface of the specimen. The orientation according to the present invention of the rotation axis of the mirror ensures that a flat scanned surface of the specimen can be scanned with the scanning apparatus.

In a concrete embodiment, the rotation axis of the mirror coincides at least largely with the optical axis of the lens or the objective. As a result, it is advantageously possible to use a small scanning mirror, since the light beam striking the scanning mirror always strikes the same central incidence point regardless of the instantaneous rotational position of the scanning mirror. A small scanning mirror moreover has low mass, which allows a high scanning frequency. Because of the particular arrangement of the rotation axis of the mirror and the optical axis, it is possible in particular to minimize distortion and deformation artifacts, representing an additional advantage of the arrangement according to the present invention. In an alternative arrangement, the rotation axis of the mirror is at least largely parallel to the optical axis of the lens or the objective.

In a further embodiment, the mirror is located after the lens or the objective in the illumination beam path. Here only the mirror is arranged rotatably or pivotably; the lens or objective is arranged in stationary fashion. The working distance of the lens or objective must be selected such that it is possible to illuminate and image the specimen after reflection at the mirror. If the working distance of the lens or objective is predefined, the rotatable or pivotable mirror must be arranged accordingly.

In an alternative embodiment, at least two mirrors are arranged after the lens or the objective in the illumination beam path. It is furthermore possible to arrange the lens or the objective between the two mirrors. In both cases, the mirror and the lens or the objective are received in a shared mount and are rotatable or pivotable together by rotation of said mount.

The mount rotates or pivots about a rotation axis that is at least largely orthogonal to the scanned surface of the specimen. This ensures that a flat scanned surface of the specimen can be scanned by the scanning unit received by the mount. For concrete implementation of an arrangement of this kind, it is generally necessary for the rotation axis of the mount to be arranged such that it is at least largely parallel to the optical axis of the imaging beam path before the mount. Optionally, the position of the rotation axis of the mount must be adapted to the mirror and lens or objective received by the mount In order to achieve the highest possible rotation or pivoting frequency for the mount, the mount must be fabricated from low-density material to have as little mass as possible.

The two scanning mirrors arranged in the beam path could be arranged parallel to one another. In this case the light beam reflected by the two mirrors exhibits a lateral offset from the light beam arriving at the two mirrors. In an alternative embodiment, the two mirrors are not arranged parallel to one another; the optical axis of the light beam reflected from the two mirrors is therefore no longer parallel to the optical axis of the light beam that arrives at the two mirrors. The light beam reflected by the two mirrors nevertheless generally has a lateral offset from the light beam originally arriving at the two mirrors. The arrangement of the mirrors defines the scanning geometry and largely predetermines the position of the specimen slide.

In a further embodiment, the optical axis of the illumination beam path before the scanning unit is at an angle with respect to the rotation axis of the scanning unit that differs from 0 degrees. The scanning unit could, in this context, have one mirror, two mirrors, two mirrors and one lens or one objective. Because of the way the beam passes through the scanning unit, the light beam deflected by the scanning unit possesses an incidence angle with respect to the scanned surface of the specimen that differs from 0 degrees.

By corresponding arrangement of at least one mirror, the incidence angle between the optical axis of the beam path and the scanned surface of the specimen can preferably be adjusted so that it differs from 0 degrees. This advantageously makes it possible to suppress the principle return reflection of the exciting light (resulting from the slide-air interface) and to block it out of the excitation and detection beam path This is very important especially because a weak blocking (bandpass) filter, which only insignificantly decreases the power of the fluorescent light to be detected, can now be used. Blocking out the principle return reflection is advantageous in particular when lasers are used for illumination, since the exciting light returning to the laser usually disrupts its stimulated emission, which can result in undesired intensity fluctuations in the laser light. It is furthermore possible to eliminate reflections at specimen slide edges which would result in disruptive interference in the vicinity of the specimen and thus also in image recording artifacts.

The angle between the optical axis of the beam path before the scanning unit and the rotation axis of the scanning unit, or the incidence angle between the optical axis of the beam path and the scanned surface of the specimen, is greater than 0 degrees and less than 20 degrees. Advantageously, in order to minimize the principle return reflection of the exciting light, the angle can be selected so that it corresponds to the Brewster angle of the slide-air transition, since the intensity of the reflected light beam is then almost zero For this purpose, however, the incident light beam must be linearly polarized, which is generally the case when laser light sources are used.

The specimen slide(s) is/are moved along one direction with the aid of a transport apparatus. As a result, the specimen slide is scanned while the scanning unit scans along said direction. The transport apparatus has an axial positioning accuracy for the specimen slide that is less than equal or equal to 10 μm. As a result, it is advantageously possible to dispense with auto focusing of the specimen or the specimen slide, provided the optical systems used has a corresponding large depth of field.

In a concrete embodiment, a plurality of light beams serve to illuminate the specimens. These could be generated by an arrangement downstream from the light source comprising mirrors and semitransparent glass plates, so that in order further to accelerate the scanning operation, a specimen slide can be illuminated simultaneously with a plurality of light beams. These light beams can have both a lateral offset from one another, and different incidence angles with respect to the scanned surface of the specimen. In similar fashion, a plurality of the light beams is used for detection. It is furthermore conceivable for a plurality of lasers to be used simultaneously as the light source. The laser(s) can in turn also emit different wavelengths in each case. A plurality of detectors could be used simultaneously for detection, so that ideally, exactly one detector is allocated to each of the illuminating beams and detected beams that is used.

In additionally advantageous fashion, only a portion of the objective aperture is used to illuminate the specimens that are to be scanned. The illuminating beam thus focused by the objective or lens has, as a result of fundamental optical relationships, a greater depth of fields compared to an illuminating beam that uses the entire objective aperture. This has an advantageous effect on the axial positioning accuracy of the transport apparatus, since that accuracy is directly correlated with the depth of field of the optical systems used. Although no diffraction-limited focusing then exists transverse to the optical axis, for the application in question here it is also generally not necessary. Partial utilization of the illuminating objective aperture creates, with respect to the detection beam path, a kind of “dark-field” illumination, so that the incidence angle between the optical axis of the illuminating beam and the scanned surface of the specimen differs from 0 degrees. This, too, minimizes undesired principle return reflections and interference phenomena.

For dark-field illumination, the exciting light is coupled into the beam path via a mirror. This mirror can be relatively small, corresponding to the aperture provided for illumination; generally the dimensions of the mirrors are only a fraction of the aperture of the lens or objective.

In a concrete embodiment, the principle reflection of the exciting light is directed via mirror to a focus position detector. This mirror can also have small dimensions if the diameter of the light beam resulting from the principle reflection has a correspondingly small cross section. The introduction of the coupling-in or coupling-out mirror means that the detection aperture is reduced by only a fraction of the total usable aperture of the objective or lens. The focus position detector could comprise a two-part or four-part photodiode, so that autofocusing of the specimen slide can be performed with the aid of the data from the focus position detector. If the depth of field in terms of illumination/detection is less than the positioning accuracy of the transport apparatus, autofocusing of the specimen slide during data recording is necessary in order to scan the specimen. This would ensure that the specimens that are scanned, located on the specimen slide, always lie within the depth of field of the exciting or detected beam during data recording, and are also in fact detected. Autofocusing could be implemented either by axial positioning of the objective or lens, or by axial positioning of the specimen slide, for example by way of the transport apparatus.

Depending on the diameter of the specimens to be detected, the optical components used in the beam path are assembled in such a way that the illumination diameter of the laser beam or beams in the specimen plane has a diameter that is greater than 1 μm and less than 300 μm. With suitable selection of the illumination diameter in the specimen plane, it is possible to scan with a spatial resolution that is optimum for identification and quantification of the specimens. Depending on the spacing between adjacent spots and their diameter, an illumination diameter in the specimen plane that satisfies the scanning theorem for detection of that pattern can be selected. A decrease in the spatial resolution results in a decrease in the data recorded, so that in addition, the duration of the recording operation can thereby advantageously be further shortened.

### BRIEF DESCRIPTION OF THE DRAWINGS

There are various possibilities for advantageously embodying and developing the teaching of the present invention. Reference is made for the purpose on the one hand to the claims, and on the other hand to the explanation below of an exemplary embodiment of the invention referring to the drawings. In conjunction with the explanation of the preferred exemplary embodiment of the invention referring to the drawings, a general explanation will also be given of preferred embodiments and developments of the teaching.

In the drawings:

FIG. 1 shows, in a schematic depiction, a first exemplary embodiment of an arrangement according to the present invention for optical scanning of a specimen;

FIG. 2 shows, in a schematic depiction, an arrangement for optical scanning of a specimen that has only one scanning mirror;

FIG. 3 shows, in a schematic depiction, an arrangement according to the present invention for optical scanning of a specimen having a mount for the two mirrors;

FIG. 4 shows, in a schematic depiction, a view of an arrangement according to the present invention for optical scanning of a specimen having a mount for the two mirrors;

FIG. 5 shows, in a schematic depiction, an arrangement for optical scanning of a specimen in which the lens or objective is located after the two mirrors in the illumination beam path;

FIG. 6 shows, in a schematic depiction, an alternative arrangement for optical scanning of a specimen in which the lens or objective is arranged between the two mirrors;

FIG. 7 shows, in a schematic depiction, an alternative arrangement for optical scanning of a specimen in which the two mirrors are not arranged parallel to one another;

FIG. 8 shows a scan pattern generated by an arrangement for optical scanning of a specimen;

FIG. 9 shows, in a schematic depiction, an arrangement for optical scanning of a specimen in which dark-field illumination is implemented;

FIG. 10 shows, in a schematic depiction, an arrangement for optical scanning of a specimen in which dark-field illumination is implemented in conjunction with a focus position detection device; and

FIG. 11 shows, in a schematic depiction, the cross section of the detection beam of FIG. 10.

### DETAILED DESCRIPTION OF THE PREFERRED EMBODIMENT

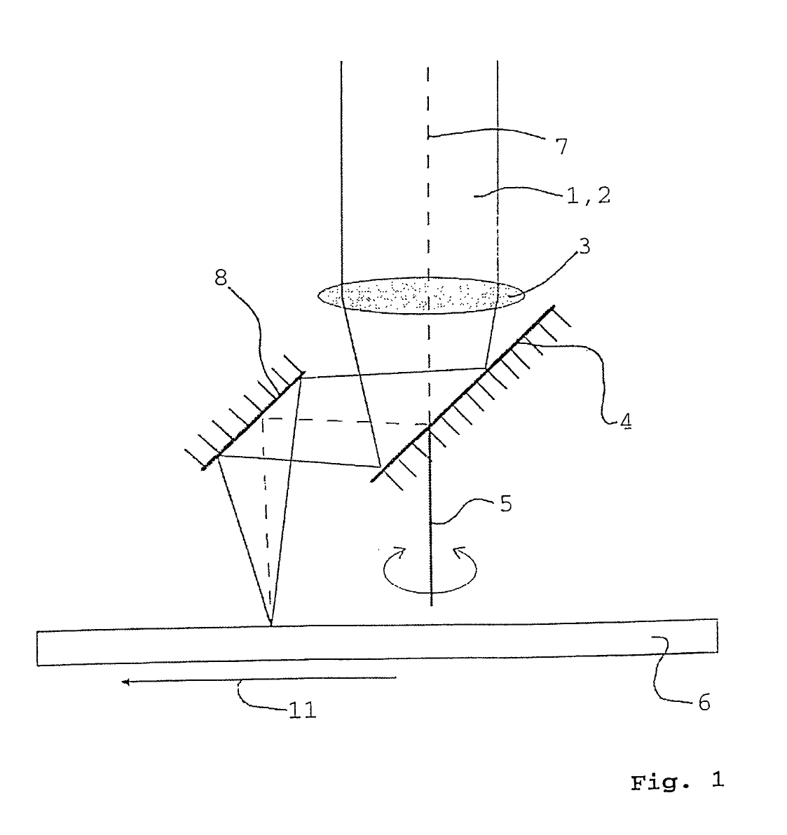

FIGS. 1, 2, 3, 5, 6, 7, 9, and 10 each show an arrangement for optical scanning of a specimen in confocal laser scanning microscopy. A lens or objective 3 and at least one scanning mirror 4 are arranged in illumination/detection beam path 1, 2. Scanning mirror 4 rotates or pivots with a rotation axis 5 that is at least largely orthogonal to the scanned surface of the specimen. The specimen is located on specimen slide 6 In the depiction selected for FIGS. 1, 3, 5, 6, 7, 9, and 10, rotation axis 5 of mirror 4 coincides with the optical axis of the lens or objective of the mirror arrangement.

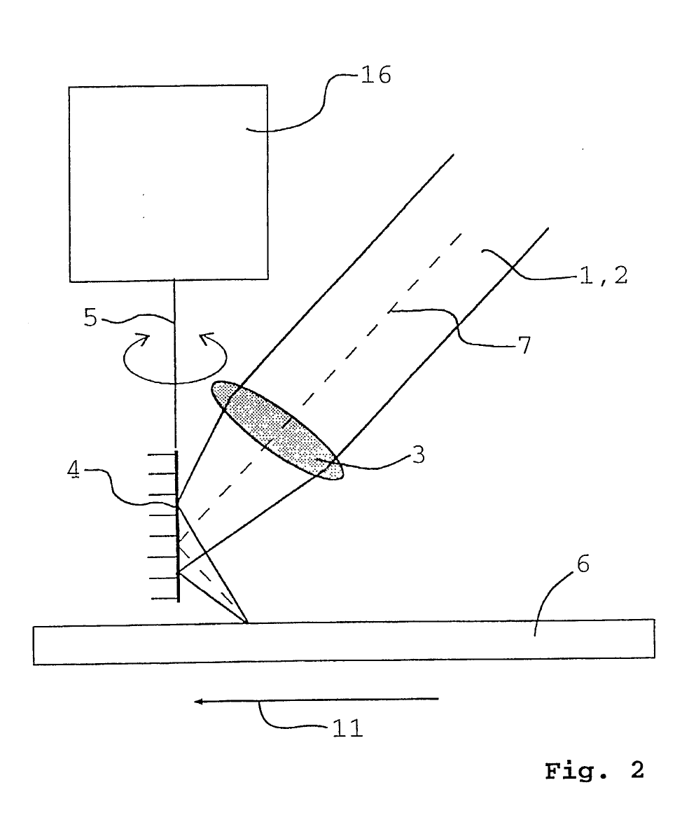

In FIG. 2, mirror 4 is located after lens 3; here as well, rotation axis 5 of mirror 4 is orthogonal to the scanned surface of the specimens located on the specimen slide 6. The light for illumination of the specimens comes from a light source (not shown in FIG. 2) and passes in collimated fashion along optical axis 7 to lens 3, which focuses the illuminating beam. The convergent illuminating beam strikes scanning mirror 4; after it is reflected, the illuminating light strikes specimen slide 6 The fluorescent light excited by the illuminating light passes along the illumination beam path in the opposite direction and strikes a beam splitter (not shown in FIG. 2) which directs the fluorescent light to a detector (also not shown).

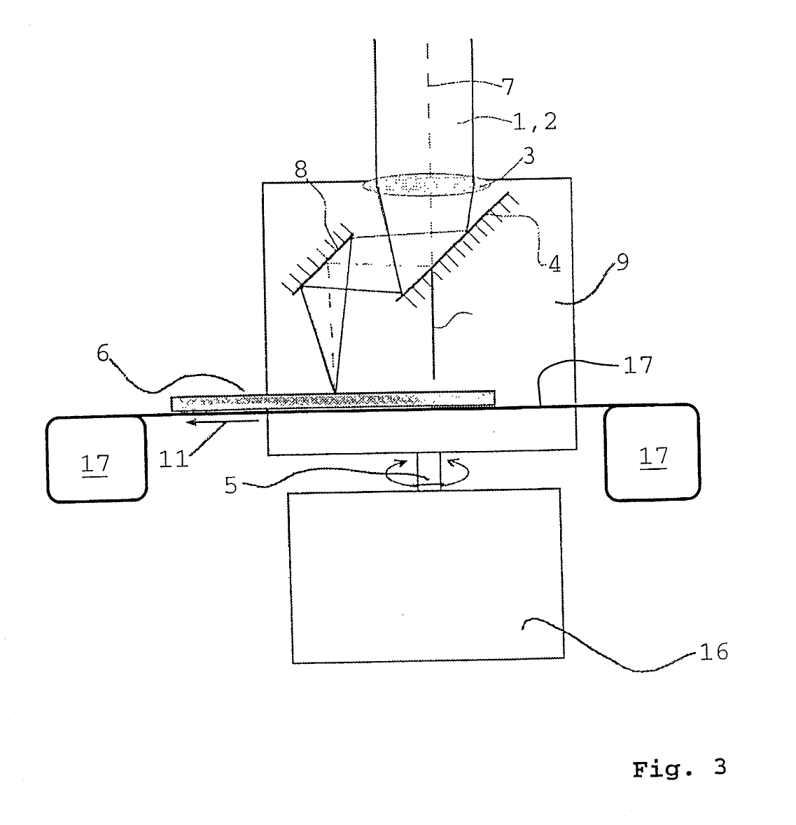

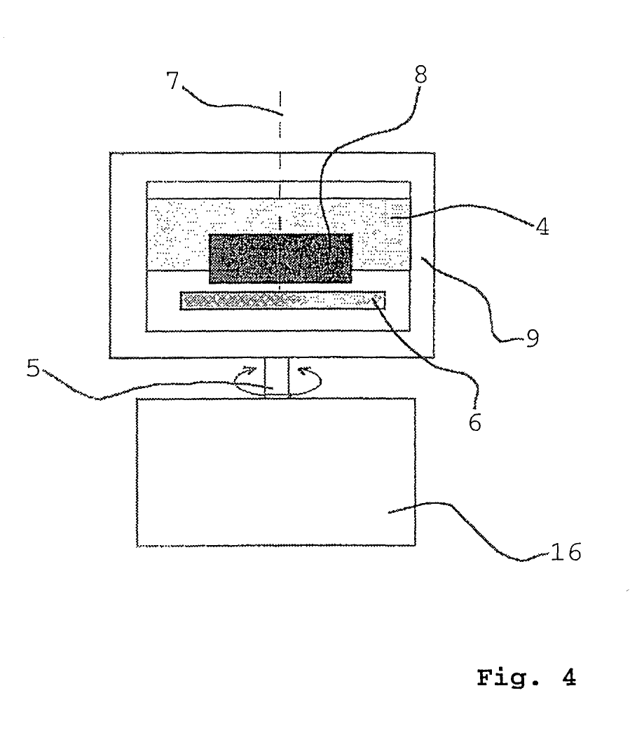

FIGS. 1, 3, 7, 9, and 10 depict embodiments according to the present invention of an arrangement for optical scanning of a specimen in which at least two mirrors 4, 8 are located after the lens or objective 3 in the illumination beam path. FIGS. 3 and 4 indicate that the two mirrors 4, 8 are received on a shared mount 9.

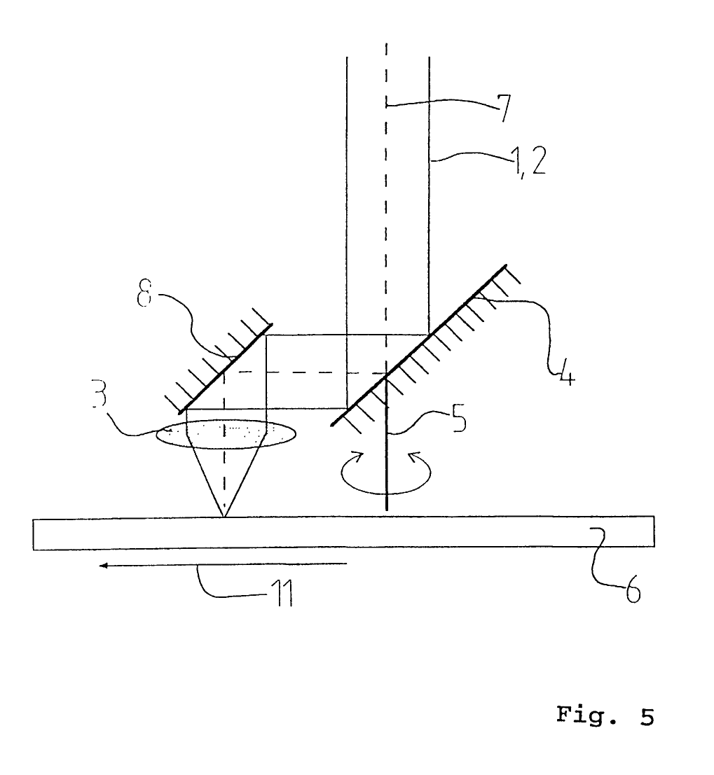

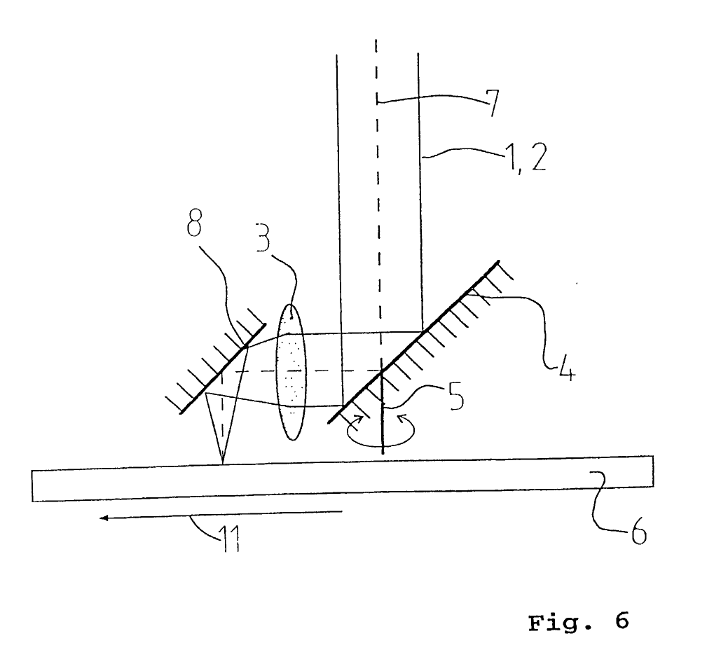

In FIG. 5, lens 3 is arranged after the two mirrors 4, 8. In an alternative embodiment as shown in FIG. 6, lens 3 is arranged between the two mirrors 4, 8. Mirrors 4, 8 and lens 3 of FIGS. 5 and 6 are received in a shared mount. As indicated in FIGS. 3 and 4, mount 9 pivots or rotates with a rotation axis 5 that is orthogonal to the scanned surface of the specimen, coincides with the optical axis of the imaging beam path before the mount. Mount 9 is fabricated from low-density material, specifically aluminum, with lightweight design.

It is evident from the embodiments shown in FIGS. 1, 3, 5, 6, 9, and 10 that the two mirrors 4, 8 are arranged parallel to one another In these embodiments the illumination beam with optical axis 7, extending orthogonally to the scanned surface of the specimen, strikes the scanned surface of the specimens orthogonally after passing through the scanning unit comprising the two mirrors 4, 8.

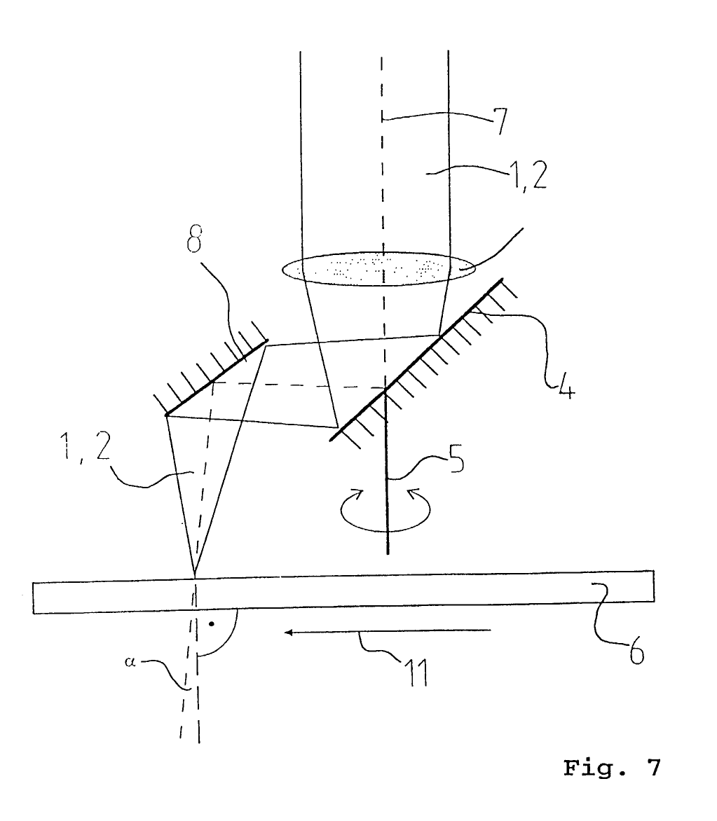

In the embodiment shown in FIG. 7, the two mirrors 4, 8 are not arranged parallel to one another. The illumination beam path with optical axis 7, initially extending orthogonally to the scanned surface of the specimen, is deflected, after passing through the lens and the scanning unit comprising mirrors 4, 8, in such a way that the optical axis of the now-deflected illumination beam strikes the scanned surface not orthogonally, but at an angle with respect to the perpendicular.

It is evident from the embodiment shown in FIG. 2 that the illumination beam path, the optical axis of the beam path before the scanning unit comprising mirror 4 is at an angle with respect to rotation angle 5 of the scanning unit that differs from 0 degrees. This once again makes it possible for the deflected illuminating beam to strike the scanning surface of the specimen in non-orthogonal fashion. In this embodiment, the incidence angle between the optical axis of the illuminating beam after deflection by scanning mirror 4, and the scanned surface of the specimen, corresponds to the Brewster angle. The principle return reflection of the exciting light from the excitation and detection beam path is thereby minimized.

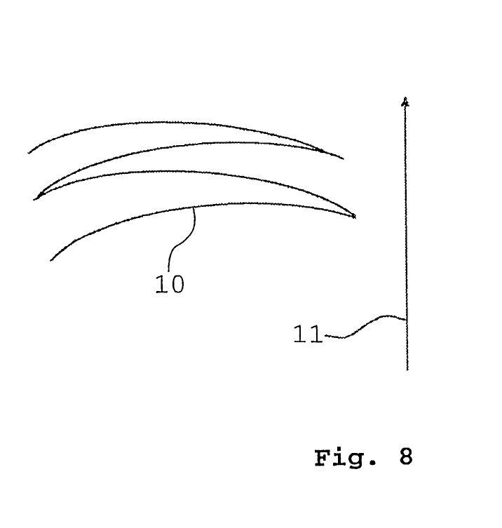

Specimen slide 6 is moved along a direction 11 by a transport apparatus (not shown in the Figures). The scanning operation of the scanning unit, and the movement of the specimen slide along a direction, generate scan pattern 10 depicted in FIG. 8, which scans all the relevant regions of the specimen slide. The transport apparatus has an axial positioning accuracy of 5 μm in terms of the focus position of the illumination and detection beam path.

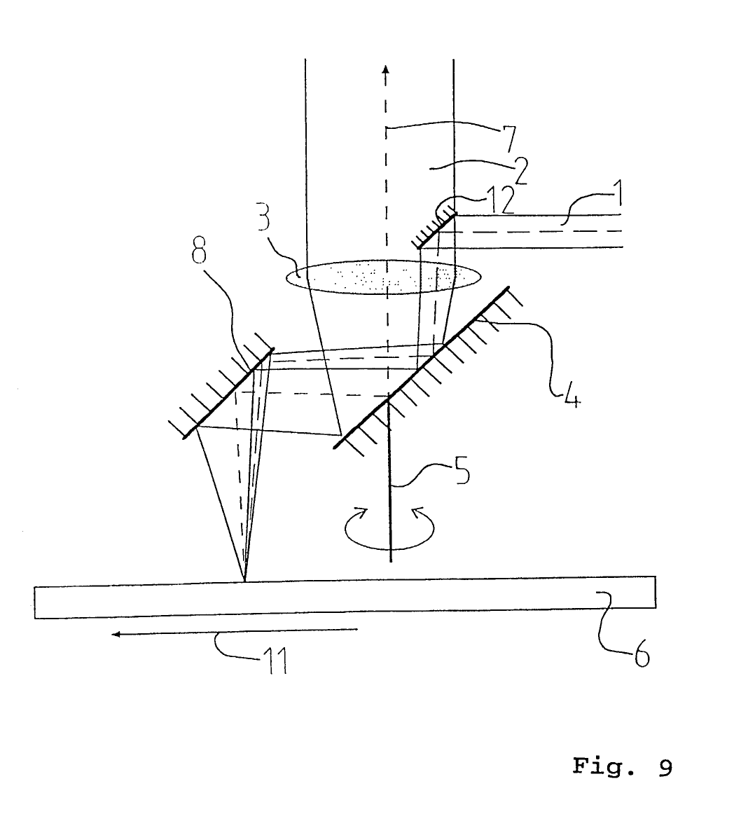

In the embodiment evident from FIG. 9, the specimens present on the specimen slide are illuminated with two light beams, specifically with illuminating beams 1 and 2. An argon krypton laser (not shown in FIG. 9), which emits light at wavelengths of 488 nm and 568 nm, serves as the light source for illuminating beam 1. The light source for illuminating beam 2 is a helium-neon laser (also not shown in FIG. 9), which emits light at a wavelength of 633 nm. The fluorescent emission excited by illuminating light at the three different wavelengths is detected simultaneously with three detectors (also not shown in FIG. 9).

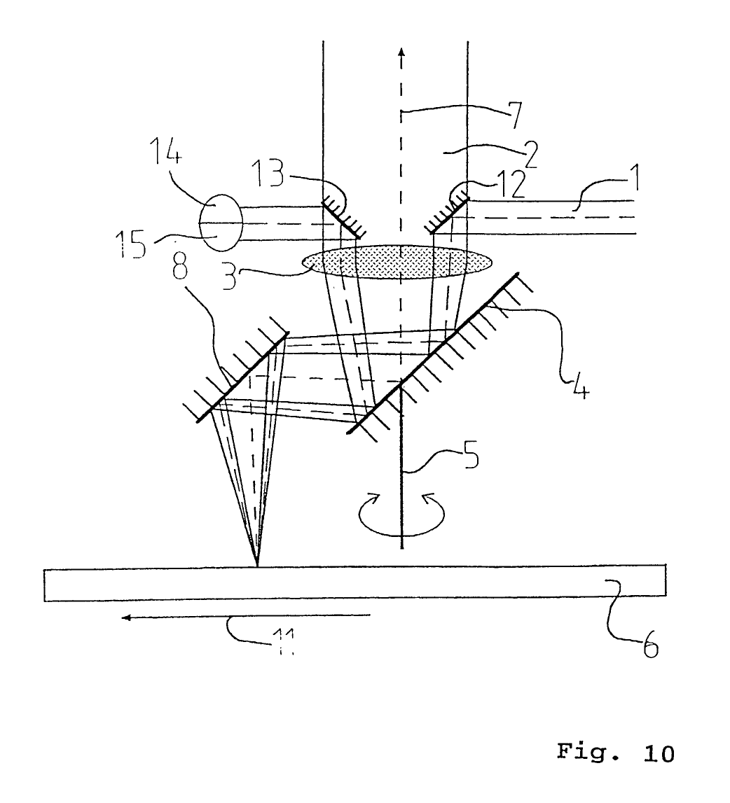

It is evident from FIGS. 9 and 10 that only a portion of the objective aperture is used to illuminate the specimens that are to be scanned. The collimated illuminating beam 1, which has a smaller cross section compared to the cross section of detected beam 2, is coupled in via a coupling-in mirror 12. In the embodiments shown in FIGS. 9 and 10, almost the entire aperture of objective 3 is utilized for detection with detected beam 2; illuminating beam 1 has a substantially smaller aperture.

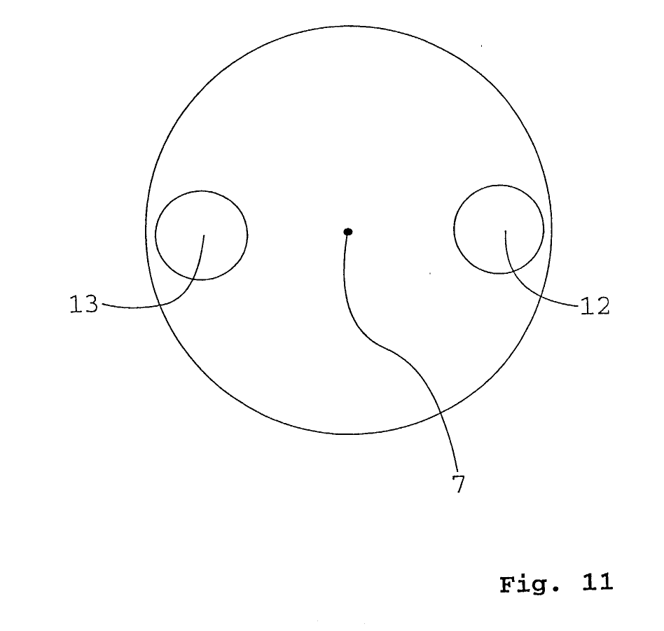

FIG. 10 depicts the fact that the principle reflection of exciting light 1 is directed via a coupling-out mirror 13 to a focus position detector 14, 15. Coupling-in mirror 12 and coupling-out mirror 13 are positioned in detection beam path 2, and therefore only slightly reduce the total available detection aperture of objective 3. FIG. 11 depicts the cross-sectional area of detected beam 2 and the cross-sectional area of coupling-in and coupling-out mirrors 12, 13 The arrangement of the two mirrors 12, 13 in the detection beam path causes the total detection aperture to be reduced by only approximately 8%, which has almost no effect.

The principle reflection of exciting light 1 strikes focus position detector 14, 15, which comprises a two-part photodiode. As a function of the focus position of specimen slide 11, one or the other part of focus position detector 14, 15 is acted upon by more light The data of focus position detector 14, 15 are conveyed to the control unit of the laser scanning microscope, which performs autofocusing of the specimen slide. Autofocusing is carried out by way of actuating elements of the transport apparatus, which in turn have position transducers that are connected to the control unit of the laser scanning microscope in which the reference and actual positions if the actuating elements are compared.

The illumination diameter of the laser beam in the specimen plane has a diameter of 50 μm. With this the labeled regions, which have a diameter of approx. 120 μm, can be unequivocally identified and localizes, and quantified in terms of their fluorescent emission, with sufficient accuracy.

In conclusion, be it noted very particularly that the exemplary embodiments set forth above serve merely to describe the teaching claimed, but do not limit it to the exemplary embodiments selected.

Parts list

| | |
|---|---|
| 1 | Illumination beam path; illuminating beam |
| 2 | Detection beam path; detected beam |
| 3 | Lens or objective |
| 4 | Scanning mirror |
| 5 | Rotation axis |
| 6 | Specimen slide |
| 7 | Optical axis of lens |
| 8 | Mirror |
| 9 | Mount |
| 10 | Scan pattern |
| 11 | Movement direction of transport apparatus |
| 12 | Coupling-in mirror |
| 13 | Coupling-out mirror |
| 14 | Focus position detector |
| 15 | Focus position detector |
| 16 | Galvanometer |
| 17 | Transport apparatus |

What is claimed is:

1. An arrangement for optical scanning of a specimen, in particular in preferably confocal laser scanning microscopy, a lens or an objective (3) and at least one scanning mirror (4) being arranged in the illumination/detection beam path (1, 2), wherein the mirror (4) rotates or pivots with a rotation axis (5) that is at least largely orthogonal to the scanned surface of the specimen.

2. The arrangement as defined in claim 1, wherein the rotation axis (5) of the mirrors (4) coincides at least largely with the optical axis of the lens or the objective (3).

3. The arrangement as defined in claim 1, wherein the rotation axis (5) of the mirrors (4)
is at least largely parallel to the optical axis of the lens or the objective (3).

4. The arrangement as defined in one claim of claim 1 through 3, wherein the mirror (4) is located after the lens or the objective (3) in the illumination beam path.

5. The arrangement as defined in one of claims 1 through 3, wherein at least two mirrors (4, 8) are arranged after the lens or the objective (3) in the illumination beam path.

6. The arrangement as defined in claim 5, wherein the two mirrors (4, 8) are held by a shared mount (9).

7. The arrangement as defined in one of claims 1 through 3, wherein the lens or the objective (3) is arranged after the two mirrors (4, 8) in the illumination beam path.

8. The arrangement as defined in one of claims 1 through 3, wherein the lens or the objective (3) is arranged between the two mirrors (4, 8).

9. The arrangement as defined in claim 7 or 8, wherein the two mirrors (4, 8) and the lens or the objective (3) are held by a shared mount (9).

10. The arrangement as defined in claim 6 or 9, wherein the mount (9) rotates or pivots with a rotation axis (5) that is at least largely orthogonal to the scanned surface of the specimen.

11. The arrangement as defined in claim 6 or 9, wherein the rotation axis of the mount (9) is arranged at least largely parallel to the optical axis (7) of the imaging beam path before the mount (9).

12. The arrangement as defined in one of claims 6 through 11 wherein the mount (9) is fabricated from low-mass/low-density material.

13. The arrangement as defined in one of claims 5 through 12, wherein the two mirrors (4, 8) are arranged parallel to one another.

14. The arrangement as defined in one of claims 5 through 12, wherein the two mirrors (4, 8) are not arranged parallel to one another

15. The arrangement as defined in one of claims 1 through 14, wherein the optical axis of the illumination beam path before the scanning unit is at an angle with respect to the rotation axis (5) of the scanning unit that differs from 0 degrees.

16. The arrangement as defined in one of claims 1 through 15, wherein preferably by corresponding arrangement of at least one mirror, the incidence angle between the optical axis of the beam path and the scanned surface of the specimen preferably differs from 0 degrees.

17. The arrangement as defined in claim 15 or 16, wherein the angle is greater than 0 and less than 20 degrees.

18. The arrangement as defined in claim 15 or 16, wherein the angle corresponds to the Brewster angle.

19. The arrangement as defined in one of claims 1 through 18, wherein a transport apparatus moves the specimen slide(s) (6) along one direction (11).

20. The arrangement as defined in claim 19, wherein the transport apparatus has an axial positioning accuracy for the specimen slide (6) that is less than or equal to 10 μm.

21. The arrangement as defined in one of claims 1 through 20, wherein one or a plurality of light beams are used for illumination.

22 The arrangement as defined in one of claims 1 through 21, wherein one or a plurality of light beams are used for detection.

23. The arrangement as defined in one of claims 1 through 22, wherein a plurality of lasers are used simultaneously as the light source.

24 The arrangement as defined in claim 23, wherein the laser(s) also emit different wavelengths in each case.

25 The arrangement as defined in one of claims 1 through 24, wherein a plurality of detectors are used simultaneously for detection.

26. The arrangement as defined in one of claims 1 through 25, wherein only a portion of the objective aperture is used to illuminate the specimens that are to be scanned.

27 The arrangement as defined in claim 26, wherein the exciting light is coupled in via a mirror (12) to illuminate the specimens to be scanned.

28. The arrangement as defined in one of claims 1 through 27, wherein the principle reflection of the exciting light is directed via a mirror (13) to a focus position detector (14, 15).

29. The arrangement as defined in claim 28, wherein the focus position detector comprises a two-part or four-part photodiode.

30. The arrangement as defined in claim 28 or 29, wherein autofocusing of the specimen slide can be performed with the aid of the data from the focus position detector.

31. The arrangement as defined in one of claims 1 through 30, wherein the illumination diameter of the laser beam or beams in the specimen plane has a diameter that is greater than 1 μm and less than 300 μm.
